(19) United States
(12) Patent Application Publication
(10) Pub. No.: US 2025/0223835 A1
(43) Pub. Date: Jul. 10, 2025

(54) Illuminating Key Fob Device and Illumination Accessory

(71) Applicants: Darrel Podzemny, Amarillo, TX (US); Daniel Dempsey, Amarillo, TX (US)

(72) Inventors: Darrel Podzemny, Amarillo, TX (US); Daniel Dempsey, Amarillo, TX (US)

(21) Appl. No.: 18/922,998

(22) Filed: Oct. 22, 2024

Related U.S. Application Data
(60) Provisional application No. 63/617,977, filed on Jan. 5, 2024.

(51) Int. Cl. E05B 17/10; B60R 25/01; B60R 25/24; F21V 23/04; F21Y 115/10

(52) U.S. Cl. CPC E05B 17/103; B60R 25/01; B60R 25/24; F21V 23/04; F21Y 2115/10

(57) ABSTRACT

An illuminating key fob device designed to enhance usability in low-light conditions is disclosed. The key fob includes an illumination source, such as an LED, to illuminate functional buttons like lock, unlock, and trunk release. The device features a control button on the side of the housing, which, when pressed, activates the illumination source. In some embodiments, the key fob includes a solar cell to supplement power from a built-in battery. The illumination source automatically deactivates after a predetermined time or when a functional button is pressed. Additionally, the invention includes a light device accessory that can be clipped or slid onto existing key fobs, featuring an illumination source activated by a control button on the accessory. The invention provides a practical solution for operating key fobs in dark environments, enhancing convenience and safety for users.

### CROSS-REFERENCE TO RELATED APPLICATION

The present application claims priority to, and the benefit of, U.S. Provisional Application No. 63/617,977 which was filed on Jan. 5, 2024 and is incorporated herein by reference in its entirety.

### FIELD OF THE INVENTION

The present invention generally relates to the field of key fobs. More specifically, the present invention relates to an illuminating key fob device that integrates advanced lighting technologies to enhance the usability of key fobs in low-light conditions. The invention features an integrated LED light source strategically positioned on or within the key fob to illuminate functional buttons such as lock, unlock, and trunk release. Additionally, the invention includes a control button for easy activation of the light. The device addresses the critical needs of individuals who frequently operate their vehicles in dark environments, offering a practical, energy-efficient solution for improved visibility and accuracy in button operation. The invention also includes an aftermarket accessory option that can be clipped or slid onto existing key fobs, ensuring widespread compatibility. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, a key fob is a small, portable device used for remotely controlling many functions of a vehicle or other systems, such as home security or garage doors. The key fob generally communicates wirelessly with the car or system via radio frequency (RF) signals or Bluetooth. Many people rely on key fobs to remotely access and operate their vehicles. However, using key fobs in low-light or dark environments can present a significant challenge. People attempting to unlock or access their vehicles at night often struggle to see the buttons on their key fobs clearly, making it difficult to locate and press the correct button. Without proper illumination, users may inadvertently press the wrong button, which can lead to accidental actions such as opening the trunk or setting off the vehicle's alarm. Such unintended actions can cause frustration, disrupt the user's routine, and even result in safety concerns. In poorly lit environments, this difficulty is compounded by the fact that many key fobs lack any sort of built-in lighting to assist in locating or identifying buttons. Existing key fobs fail to address the illumination issue effectively, and people desire a device that can illuminate key fob buttons, providing case of use, reducing errors, and improving the user experience in low-light conditions.

Therefore, there exists a long-felt need in the art for an illuminated key fob that improves the usability of key fobs in low-light or dark environments. Additionally, there is a long-felt need for a key fob that prevents accidental pressing of incorrect buttons, such as triggering the car alarm or opening the trunk, which can lead to frustration and inconvenience. Furthermore, there is a long-felt need for a key fob that is user-friendly, energy-efficient and incorporates modern power solutions. Moreover, there is a demand for a universal aftermarket accessory that can be easily attached to existing key fobs to provide illumination without requiring a complete replacement of the fob. Finally, there is a long-felt need for a key fob that allows users to selectively illuminate their key fob via a button press to view it during lowlight hours.

The subject matter disclosed and claimed herein, in one embodiment thereof, comprises an illuminated key fob device designed to address the difficulties users face in low-light environments. The device includes an integrated LED positioned on or within the key fob housing to illuminate the functional buttons, such as lock, unlock, and trunk release. A control button is placed on the side of the key fob, allowing users to activate the light independently of other functions. An aftermarket accessory is also disclosed that can be clipped or slid onto existing key fobs to illuminate the functional buttons, such as lock, unlock, and trunk release of the key fobs.

In this manner, the illuminated key fob device of the present invention accomplishes all of the foregoing objectives and provides a novel solution that provides clear illumination of the functional buttons of a key fob. The device prevents accidental presses and enhances the user experience, especially at night. The aftermarket accessory offers a practical solution for users of existing key fobs, allowing users to retrofit their devices with the illumination feature without needing to purchase a new fob.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an illuminating key fob device. The key fob device comprises a housing, one or more functional buttons, an illumination source is disposed on the top surface of the housing and configured to illuminate the one or more functional buttons, a control button is disposed on a side surface of the housing and is adapted to activate the illumination source when pressed, a power source is disposed within the housing for providing electrical power to the illumination source, wherein the illumination source illuminates the one or more functional buttons upon activation by the control button and automatically turns off after a predetermined time or upon releasing the control button.

In another embodiment, an illuminating key fob device is disclosed. The device includes a housing, one or more functional buttons disposed on a top surface of the housing, an illumination source disposed within the housing and adapted to illuminate the one or more functional buttons from within when activated, a control button disposed on a side surface of the housing for manually activating the illumination source, wherein a solar cell disposed on the housing and configured to provide electrical power to the illumination source, wherein the key fob is further powered by a built-in battery when the solar cell is not operational.

In still another embodiment, a light device accessory for use with a key fob is described. The accessory includes a housing configured to be removably attached to an existing key fob, a clip mechanism disposed on the housing, adapted to securely attach the light device to the key fob, an illumination source disposed on the housing for illuminating one or more buttons of the key fob, an integrated battery within the housing for powering the illumination source independently of the key fob's battery, and a control button disposed on the housing for activating the illumination source when pressed.

In still another aspect, a light device accessory for use with a key fob is disclosed. The accessory includes a housing having a first sliding channel disposed along a first side surface and a second sliding channel disposed along a second side surface, wherein the sliding channels are configured to allow the housing to slide onto and attach to the key fob, an illumination source is disposed on the housing and is adapted to provide illumination to the key fob, an integrated battery is disposed within the housing for powering the illumination source, and a top surface of the housing is adapted to be pressed to activate the illumination source.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of illuminating auto home key fob device of the present invention in accordance with the disclosed structure;

FIG. 2 illustrates a perspective view showing another embodiment of the illuminating auto home key fob device of the present invention in accordance with the disclosed structure;

FIG. 3 illustrates a perspective view of a light device accessory of the present invention adapted to be used with existing key fobs in accordance with one embodiment of the present invention; and

FIG. 4 illustrates a perspective view of another embodiment of the light device accessory of the present invention adapted to be used with existing key fobs in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an illuminated key fob that improves the usability of key fobs in low-light or dark environments. Additionally, there is a long-felt need for a key fob that prevents accidental pressing of incorrect buttons, such as triggering the car alarm or opening the trunk, which can lead to frustration and inconvenience. Furthermore, there is a long-felt need for a key fob that is user-friendly, energy-efficient and incorporates modern power solutions. Moreover, there is a demand for a universal aftermarket accessory that can be easily attached to existing key fobs to provide illumination without requiring a complete replacement of the fob. Finally, there is a long-felt need for a key fob that allows users to selectively illuminate their key fob via a button press to view it during lowlight hours.

The present invention, in one exemplary embodiment, is an illuminating key fob device. The device includes a housing, one or more functional buttons disposed on a top surface of the housing, an illumination source disposed within the housing and adapted to illuminate the one or more functional buttons from within when activated, a control button disposed on a side surface of the housing for manually activating the illumination source, wherein a solar cell disposed on the housing and configured to provide electrical power to the illumination source, wherein the key fob is further powered by a built-in battery when the solar cell is not operational. Key fobs manufactured by car manufacturers includes a feature that will allow the device to illuminate for 10 seconds when first disturbed and then shut off automatically if no feature is activated by pressing other functions. The device will be activated by simply picking it up.

Reference will now be made in detail to the present preferred embodiments of the invention, examples of which are illustrated in the accompanying drawings. Wherever possible, the same reference numerals are used in the drawings and the description to refer to the same or like parts.

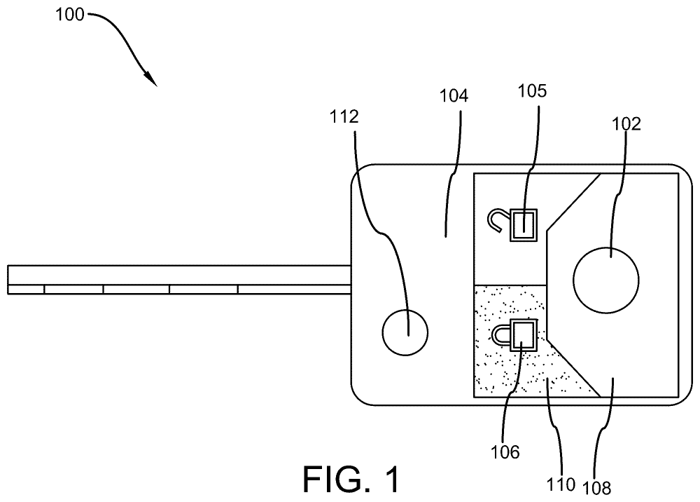

Referring initially to the drawings, FIG. 1 illustrates a perspective view of illuminating key fob device 100 of the present invention in accordance with the disclosed structure. The illuminating auto home key fob device 100 of the present invention is designed as an innovative fob that is easier to use in low-light or dark environments than existing fobs. More specifically, the key fob 100 is configured to illuminate the functional buttons 105 (as will be described more fully below) such as lock, unlock, trunk release, etc. disposed thereon for helping users to locate and operate the buttons with case when lighting conditions are poor. The key fob device 100 includes an illumination source 102 preferably in the form of an LED light (of any color) disposed on the top surface 104 of the key fob 100. In the present embodiment, the illumination source 102 is disposed on the surface where the operating/functional buttons 105 of the key fob 100 are disposed. However, the source 102 may be located anywhere on the device in different embodiments.

A LED control button 106 is disposed in the device 100 and preferably (but not limited to) on a side surface 108 of the key fob device 100. The button 106 is designed to be easily distinguishable from other buttons 105 of the fob to prevent confusion. In the preferred embodiments, a tactile sensation top surface 110 is disposed on the button 106, such as but not limited to a raised top surface 110. In some embodiments, a visual cue may be provided on the button 106 for identification thereof. The LED control button 106 is adapted to be pressed such that the illumination source 102 illuminates when the button 106 is pushed once or continually pressed. The activated illumination source 102 then illuminates the top surface 104 of the key fob 100, thereby making the making the operating buttons 105 visible and easier to use in low-light environments.

In the present embodiment, the illumination source 102 is built-in in the key fob 100 during manufacturing of the key fob 100 and uses electrical power for the operation thereof from the built-in battery 112 of the key fob 100. In one embodiment, the battery 112 can be solar powered to extend the charging life of the battery 112. The intensity of the light of the illumination source 102 is strong enough to clearly illuminate the key fob buttons but not so bright that it causes glare or discomfort for the user. In some embodiments, the LED 102 may automatically turn off after a predetermined time such as 5 seconds to conserve power. In other embodiments, the LED 102 may turn off when the user presses any of the operating buttons 105 (like lock/unlock), indicating that the intended action has been completed and the LED 102 is no longer needed for illumination. In some embodiments, the LED 102 may turn off when the LED control button 106 is released by the user (in a continuous pressing version).

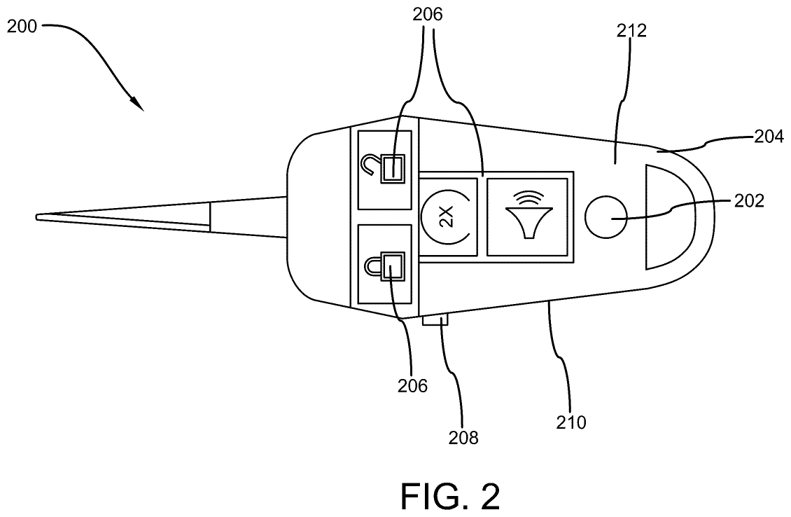

FIG. 2 illustrates a perspective view showing another embodiment of the illuminating auto home key fob device 100 of the present invention in accordance with the disclosed structure. In one embodiment, the key fob 200 has a built-in LED 202 inside the housing 204. The LED 202 is adapted to be activated when any of the operation buttons 206 is pressed. A functional control button 208 is also disposed on side surface 210 of the housing 204. The button 208 can also be pressed to activate the LED 202. The LED 202, when activated, illuminates the operation buttons 206 from within the fob, thereby enabling a user to easily operate the key fob 200 even in dark areas.

When any of the operation buttons 206 is pressed, the LED 202 activates for a predetermined time period. Also, the LED 202 activates when the functional control button 208 is pressed and is deactivated when the button 208 is released by the user. A solar cell 212 is disposed in the housing 204 for providing electrical power to the LED 202 for illumination and when the solar cell 212 is not operational, then the electrical power from the battery of the key fob 200 is provided to the LED 202.

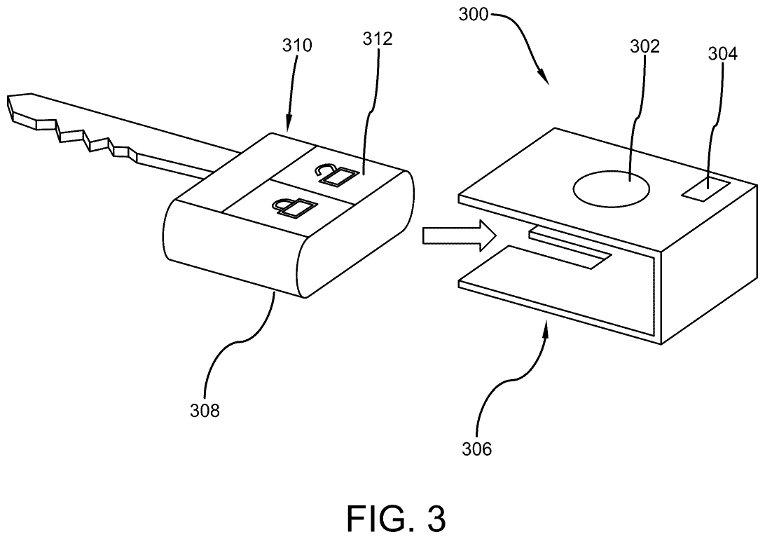

FIG. 3 illustrates a perspective view of a light device accessory of the present invention adapted to be used with existing key fobs in accordance with one embodiment of the present invention. In the present embodiment, an aftermarket key fob illumination accessory 300 is designed to be used as an aftermarket accessory with existing key fobs. The light device 300 includes an LED 302 and an integrated battery 304 which enables the LED 302 to work independently of the primary battery of a key fob with which the light device 300 is used. The light device 300 can be removably attached to a conventional key fob using a clip 306 or any other fastener of the like. The clip 306 is preferably spring-loaded and can attach to a key fob. The clip 306 can easily slide the light device 300 onto a key fob. In use, the clip 306 adheres to the bottom surface 308 of the key fob 310 and the LED is positioned on the top surface 312 of the key fob 310. The clip 306 prevents the unintentional movement of the accessory 300 on the key fob 310.

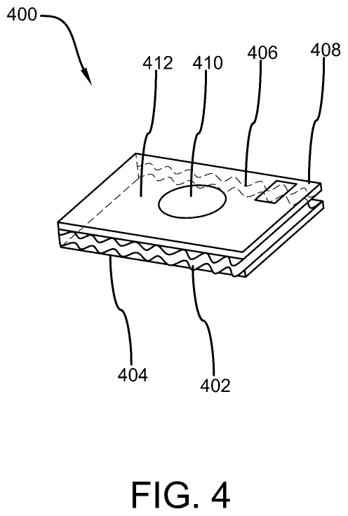

FIG. 4 illustrates a perspective view of another embodiment of the light device accessory of the present invention adapted to be used with existing key fobs in accordance with one embodiment of the present invention. In the present embodiment, the light device accessory 400 includes a sliding channel along each side surface of the accessory 400. Specifically, a first sliding channel 402 is disposed along the first side 404 and a second sliding channel 406 is disposed along the second side 408 thereof. The accessory 400 is adapted to slide on a key fob using the sliding channels 402,406 wherein the sliding channels 402,406 are secured and adhered to the side surface of a key fob. The sliding channels are non-slipping and remain secured to the key fob. An LED 410 is disposed on the accessory 400 for providing the illumination to operate the key fob in dark areas. The top surface 412 of the accessory 400 can be pushed or pressed to illuminate the LED 410.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “illuminating key fob device”, “key fob device”, and “device” are interchangeable and refer to the illuminating key fob device 100,200 of the present invention. Similarly, as used herein “aftermarket key fob illumination accessory”, “light accessory device”, and “accessory” are interchangeable and refer to the aftermarket key fob illumination accessory 300,400 of the present invention

Notwithstanding the forgoing, the illuminating key fob device 100,200 and the aftermarket key fob illumination accessory 300,400 of the present invention can be of any suitable size and configuration as is known in the art without affecting the overall concept of the invention, provided that it accomplishes the above stated objectives. One of ordinary skill in the art will appreciate that the illuminating key fob device 100,200 and the aftermarket key fob illumination accessory 300,400 as shown in the FIGS. are for illustrative purposes only, and that many other sizes and shapes of the illuminating key fob device 100,200 and the aftermarket key fob illumination accessory 300,400 are well within the scope of the present disclosure. Although the dimensions of the illuminating key fob device 100,200 and the aftermarket key fob illumination accessory 300,400 are important design parameters for user convenience, the illuminating key fob device 100,200 and the aftermarket key fob illumination accessory 300,400 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An illuminating key fob device comprising:
a housing comprised of a top surface and a side surface;
a functional button disposed on the top surface;
an illumination source disposed on the top surface; and
an LED control button disposed on the side surface, wherein the LED control button is distinguishable from the functional button and wherein the LED control button activates the illumination source to illuminate the function button.

2. The illuminating key fob device of claim 1, wherein the illumination source comprises an LED.

3. The illuminating key fob device of claim 2, wherein the LED is configured to deactivate automatically after a predetermined time period.

4. The illuminating key fob device of claim 2, wherein the LED deactivates when the functional buttons is pressed.

5. The illuminating key fob device of claim 1 further comprising a battery integrated within the housing to power the illumination source.

6. The illuminating key fob device of claim 5, wherein the battery is solar-powered.

7. The illuminating key fob device of claim 1, wherein the LED control button is comprised of a tactile feature to distinguish the LED control button from the functional button.

8. The illuminating key fob device of claim 1, wherein the illumination source is disposed adjacent to the functional button.

9. An aftermarket key fob illumination accessory comprising:
a housing attached to a key fob;
an illumination source disposed on the housing;
a power source integrated within the housing, wherein the power source powers the illumination source; and
a fastener that secures the housing to the key fob, wherein the illumination source is positioned to illuminate a functional button of the key fob when activated.

10. The aftermarket key fob illumination accessory of claim 9, wherein the illumination source comprises an LED.

11. The aftermarket key fob illumination accessory of claim 9, wherein the fastener comprises a spring-loaded clip configured to attach to a key fob.

12. The aftermarket key fob illumination accessory of claim 11, wherein the clip is configured to adhere to a bottom surface of the key fob and secure the illumination source on the top surface.

13. The aftermarket key fob illumination accessory of claim 9, wherein the fastener comprises a pair of sliding channels configured to secure the housing to opposing side surfaces of the key fob.

14. The aftermarket key fob illumination accessory of claim 9 further comprised of a clip.

15. A key fob device comprising:
a housing comprised of a top surface and a side surface;
a functional button disposed on the top surface;
an illumination source disposed on the housing configured to illuminate the functional button;
a control button disposed on the side surface;
a power source for providing power to the illumination source; and
wherein the illumination source is automatically activated when the functional button is pressed and deactivates after a predetermined time period or when the control button is pressed.

16. The key fob device of claim 15, wherein the illumination source comprises an LED.

17. The key fob device of claim 15, wherein the housing is comprised of a solar cell.

18. The key fob device of claim 17, wherein the illumination source is powered by a solar-powered battery.

19. The key fob device of claim 15, wherein the illumination source is deactivated upon pressing the functional button.

20. The key fob device of claim 15, wherein the control button is comprised of a raised surface for tactile differentiation from the functional button.
